(19) United States
(12) Patent Application Publication
(10) Pub. No.: US 2009/0126228 A1
(43) Pub. Date: May 21, 2009

(54) SHOE

(76) Inventor: Yu-Tuan LEE, Taipei (TW)

Correspondence Address: BIRCH STEWART KOLASCH & BIRCH, PO BOX 747, FALLS CHURCH, VA, 22040-0747, US

(21) Appl. No.: 12/272,541

(22) Filed: Nov. 17, 2008

(30) Foreign Application Priority Data
Nov. 21, 2007 (TW) 096144182

(51) Int. Cl. A43B 7/04; A43B 21/02; H02N 2/18

(52) U.S. Cl. 36/83; 310/311; 36/34 R

(57) ABSTRACT

A shoe includes a sole, a potential generating unit, a first conductive unit and a second conductive unit. The sole has a first surface and a second surface opposite to the first surface. The potential generating unit has a high potential outputting terminal and a low potential outputting terminal. The first conductive unit is electrically connected with the high potential outputting terminal of the potential generating unit and is exposed to the first surface of the sole. The second conductive unit is electrically connected with the low potential outputting terminal of the potential generating unit and is exposed to the second surface of the sole.

### CROSS REFERENCE TO RELATED APPLICATIONS

This Non-provisional application claims priority under 35 U.S.C. §119(a) on Patent Application No(s). 096144182 filed in Taiwan, Republic of China on Nov. 21, 2007, the entire contents of which are hereby incorporated by reference.

### BACKGROUND OF THE INVENTION

1. Field of Invention

The invention relates to a shoe which can generate an electrical potential to the human body.

2. Related Art

As technologies are getting advanced, human life is improved, but at the same time the pollution to the natural environment is getting worse. The pollution affects the wild life's existence, and endangers the human's health as well. An obvious result is the generation of positive ions in the environment which causes the unbalance of the positive and negative ions in the human body. Studies have shown that an excess of positive ions in the environment can cause discomfort and symptoms such as headaches and nausea in some people.

Recently the electric field therapy is getting popular. The electric field therapy applies an electric field to the human body, and neutralizes the positive ions around the human body to improve the balance of positive and negative ions in the body. The electric field therapy is designed to eliminate the discomfort and symptoms caused by the unbalance of ions and to improve the human health. But until now, most electric field therapy is carried out by a portable equipment, or by an equipment which is built into a furniture, such as a bed, chair or sofa.

The electric field therapy requires time to take effect, so a continuous therapy is important and necessary. The current equipments for the electric field therapy require the users to spend time to operate everyday. Many users can not continue their therapies everyday after a period of time for personal reasons. Since the shoes are necessary for most people in their everyday life, so it seems to be a good idea to carry out the electric field therapy by using the shoes.

### SUMMARY OF THE INVENTION

Regarding the above-mentioned problems, it is an objective of the invention to provide an apparatus, which can provide the electric field therapy by using a shoe. Thus, the user can take the electric field therapy in their everyday life easily.

In this invention, there is a sole, a potential generating unit, a first conductive unit and a second conductive unit. The sole has a first surface and a second surface opposite to the first surface. The first conductive unit is electrically connected to the high potential outputting terminal of the potential generating unit and is exposed to the first surface of the sole. The second conductive unit is electrically connected to the low potential outputting terminal of the potential generating unit and is exposed to the second surface of the sole.

By wearing the shoe of the invention on the foot, the user's body can receive an electric potential related to the ground of the Earth, the electric field from the sole of the shoe is applied to the human body, and the user can get the electric field therapy.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a diagram showing a shoe according to the first example of the preferred embodiment of the invention; and

FIG. 2 is another diagram of a shoe according to the second example of the preferred embodiment of the invention.

### DETAILED DESCRIPTION OF THE INVENTION

The present invention will be apparent from the following detailed description, which proceeds with reference to the accompanying drawings, wherein the same references relate to the same elements.

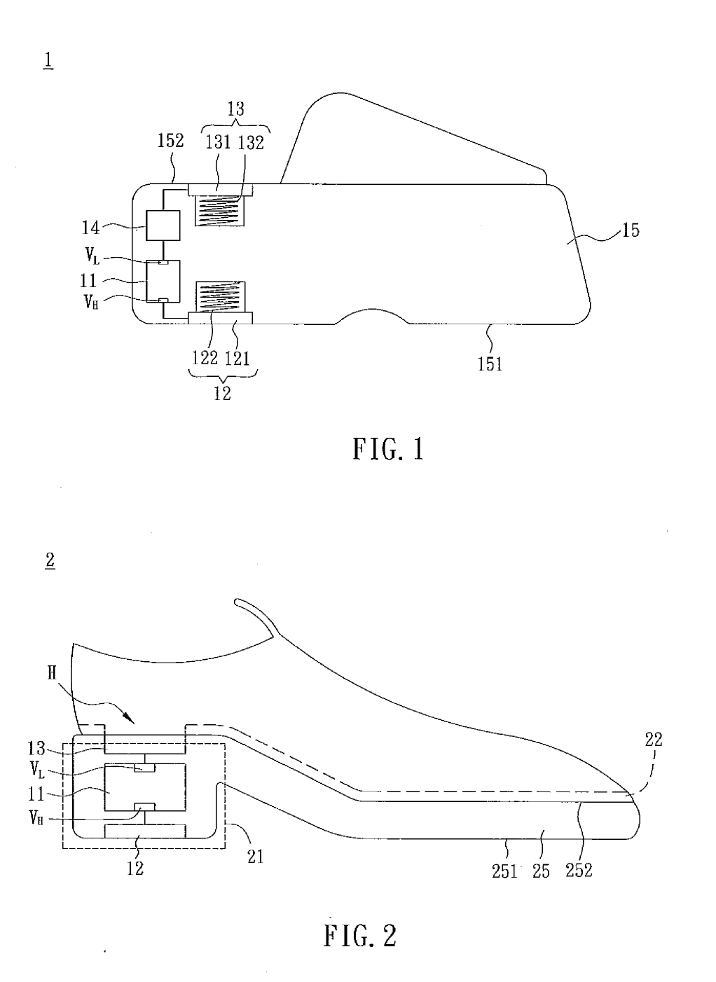

Referring to FIG. 1, the shoe of the invention consists of a potential generating unit 11, a first conductive unit 12, a second conductive unit 13 and a sole 15.

The sole 15 has a first surface 151 and an opposite second surface 152. The sole 15 is made by a non-conductive material, such as rubber, plastic, or wood.

The potential generating unit 11 has a high potential outputting terminal V_{H} and a low potential outputting terminal V_{L}. In the application the potential generating unit 11 can be a battery, a piezoelectric generator, an inverter or a power generator. And in general, the preferred outputting voltage is around 1 KV to 9 KV.

Referring to FIG. 1, in the embodiment, the first conductive unit 12 is connected to the high potential outputting terminal V_{H} of the potential generating unit 11, and the first conductive unit 12 consists of a metal plate 121, and the metal plate 121 is attached to the first surface 151 of the sole 15. The second conductive unit 13 is connected to the low potential outputting terminal V_{L} of the potential generating unit 11, and the second conductive unit 13 consists of a metal plate 131, and the metal plate 131 is attached to the second surface 152 of the sole 15. Furthermore, to make a comfortable shoe 1 to wear, the metal plate 121 and 131 are connected to springs 122 and 132 to construct a buffering structure.

Referring to FIG. 1, in the embodiment, the first conductive unit 12 consists of a metal plate 121 and a spring 122, the second conductive unit 13 consists of a metal plate 131 and a spring 132, but it is up to the users' choice to select any combinations of these elements to construct their own conductive units 12 and 13.

Furthermore, in the embodiment, the first and the second conductive units 12 and 13 are not limited to use the metal plate 121, 122 and the spring 131, 132, there are various kinds of conductive materials could be used, such as the conductive rubber can also be used to construct the conductive units 12 and 13.

Referring to FIG. 1, the first conductive unit 12 is touched with the ground of the Earth, and connects to the potential generating unit 11's high potential outputting terminal V_{H}, the low potential outputting terminal V_{L} of the potential generating unit 11 is connected to the second conductive unit 13, which means a lower potential than the ground of the Earth is applied at the second conductive unit 13. When the user puts this shoe on, the bottom of his foot will touch the second conductive unit 13, and the negative charge will be charged to the body through the foot.

Referring to FIG. 1, the shoe of the invention further consists of a current limiting unit 14, which is connected to the potential generating unit 11 and the second conductive unit 13. In the embodiment, the current limiting unit 14 is a resistor or a fuse, and is used to limit the current flowing through the potential generating unit 11, the first conductive unit 12 and the second conductive unit 13, in order to protect the human body from electrical shock.

Furthermore, in the embodiment, the current limiting unit 14 can be put anywhere in the path of the current flowing from the first conductive unit 12 to the second conductive unit 13.

Referring to the shoe 2 of the FIG. 2, compared to the shoe 1 of the FIG. 1, the shoe 2 has a heel 21 attached to the sole 25, and the potential generating unit 11, the first conductive unit 12 and the second conductive unit 13 are installed in the heel 21. The heel 21 can be made by non-conductive materials, such as rubber, plastic or wood.

Furthermore, the shoe 2 further consists of an insole 22, which is placed on the second surface 252 of the sole 25. The insole 22 has an opening H, and the second conductive unit 13 is exposed at the opening H, so that the user's foot can contact with the second conductive unit 13 directly.

Furthermore, the insole 22 can be made by conductive materials. The conductive materials could be a conductive rubber. When the whole insole 22 is conductive, the opening will not be needed, and the user can receive the charge from the potential generating unit 11 through the conductive insole 22.

In summary, the shoe of the invention, by installing a potential generating unit in it, when the high potential output terminal is connected to the ground and the low potential output terminal is connected to the human body, the human body can be charged with negative charges. Or when the high potential output terminal is connected to the human body and the low potential output terminal is connected to the ground, the human body can become a positive potential object to attract the negative ions in the surrounding environment. Both of the above configurations can be achieved by the invention, whichever is more preferable to the user.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shoe, comprising:
a sole with a first surface and a second surface at the opposite side of the first surface;
a potential generating unit with a high potential output terminal and a low potential output terminal;
a first conductive unit, which is connected to the high potential output terminal of the potential generating unit, and exposed to the first surface of the sole; and
a second conductive unit, which is connected to the low potential output terminal of the potential generating unit, and exposed to the second surface of the sole.

2. The shoe of claim 1, wherein the potential generating unit is a battery, a piezoelectric generator, an inverter, or a power generator.

3. The shoe of claim 1, wherein the first conductive unit or the second conductive unit is made by conductive materials.

4. The shoe of claim 3, wherein the conductive material is conductive rubber.

5. The shoe of claim 1, wherein the first conductive unit or the second conductive unit has a metal plate to connect to the high potential or low potential output terminal of the potential generating unit, and exposed to the first surface or the second surface of the sole.

6. The shoe of claim 5, wherein the first conductive unit or the second conductive unit further has a spring connected to the metal plate.

7. The shoe of claim 1, further comprising a current limiting unit, which is electrically connected to the potential generating unit and the first or second conductive unit.

8. The shoe of claim 7, wherein the current limiting unit is a resistor or fuse.

9. The shoe of claim 1, further comprising an insole which is placed on the sole.

10. The shoe of claim 9, wherein the material of the insole is conductive rubber.

11. The shoe of claim 9, wherein the insole has an opening, and one of the first or the second conductive unit is exposed at the opening.

12. The show of claim 1, further comprising a heel which is attached to the sole, and the potential generating unit is installed inside the heel.
